(19) United States
(12) Patent Application Publication
(10) Pub. No.: US 2009/0050512 A1
(43) Pub. Date: Feb. 26, 2009

(54) One-way valve with flapper concept for vacuum bag

(76) Inventor: Linh Pham, Chula Vista, CA (US)

Correspondence Address: OSTRAGER CHONG FLAHERTY & BROITMAN PC, 570 LEXINGTON AVENUE, FLOOR 17, NEW YORK, NY, 10022-6894, US

(21) Appl. No.: 12/075,755

(22) Filed: Mar. 13, 2008

Related U.S. Application Data
(60) Provisional application No. 60/966,061, filed on Aug. 24, 2007.

(51) Int. Cl. F16K 25/00; F16K 15/14; B65D 81/20; F16K 31/44; B65D 33/01; B65D 33/25

(52) U.S. Cl. 206/524.8; 383/42; 383/103; 251/170; 137/855

(57) ABSTRACT

A one-way valve allows air to be drawn from a collapsible, flexible, airtight bag using a vacuum source. When the vacuum source is removed, the one-way valve prevents air from reentering the bag. The valve assembly comprises: a valve base comprising an opening, a seat disposed along a periphery of the opening, a flange surrounding the seat, and first and second pivot supports; a flapper comprising a diaphragm that is deformable and overlies the opening; and a cap pivotably supported by the first and second pivot supports for pivoting between first and second angular positions, the cap comprising at least one vent hole. The cap maintains the diaphragm in contact with the seat along an entire perimeter of the seat when the cap is in the first angular position and does not maintain the diaphragm in contact with the seat along its entire perimeter when the cap is in the second angular position.

### RELATED PATENT APPLICATION

This application claims the benefit, under Title 35, United States Code, §119(e), of U.S. Provisional Application No. 60/966,061 filed on Aug. 24, 2007.

### BACKGROUND OF THE INVENTION

This invention generally relates to evacuable storage containers, and in particular, to evacuable reclosable storage bags.

Collapsible, evacuable storage containers typically include a flexible, airtight bag, an opening through which an article is inserted inside the bag, and a fixture through which excess air is evacuated. A user places an article into the bag through the opening, seals the opening, and then evacuates the air in the bag through the fixture. With the bag thus evacuated, a compressible article contained therein may be significantly compressed so that it is easier to transport and requires substantially less storage space.

Collapsible, evacuable storage containers are beneficial for reasons in addition to those associated with compression of the stored article. For example, removal of the air from the storage container inhibits the growth of destructive organisms, such as moths, silverfish, and bacteria, which require oxygen to survive and propagate. Moreover, such containers, being impervious to moisture, inhibit the growth of mildew.

Not only large, compressible items such as clothing may be stored in a collapsible, evacuable storage container. For example, it may be desirable to store bulk items made of small particles, such as powders or granulated resins, in an evacuated container. One situation that commonly occurs is that a particular bulk item is shipped in a large, rigid container such as a drum. Bulk items may be moisture sensitive and are sealed against moisture during shipment. But many times a user does not need to use the entire contents of the large container, and so once exposed to the moisture in the air the remaining bulk contents quickly become unusable and are thus wasted.

One collapsible, reusable, evacuable storage container is shown in U.S. Pat. No. 5,480,030. This patent discloses a one-way air valve assembly having a flexible diaphragm that seals against a valve seat. The valve assembly also has vanes positioned to prevent the bag material or bag contents from obstructing air holes or the diaphragm while air is being evacuated through the valve assembly.

There is a continuing need for improvements in the valve assembly of such evacuable storage containers. For example, improvements in the valve assembly structure that enhance the sealing function are desired in order to ensure that the storage container will be leakproof when evacuated.

### BRIEF DESCRIPTION OF THE INVENTION

The invention is directed to improvements in the valve assembly of a collapsible, evacuable storage container. Such storage containers have a one-way valve assembly that allows air to be drawn from a collapsible, flexible, airtight bag using a vacuum source. When the vacuum source is removed, the one-way valve prevents air from re-entering the bag.

One aspect of the invention is a valve assembly comprising: a valve base comprising an opening, a seat disposed along a periphery of the opening, a flange surrounding the seat, and first and second pivot supports; a flapper comprising a diaphragm that is deformable and overlies the opening; and a cap pivotably supported by the first and second pivot supports for pivoting between first and second angular positions, the cap comprising at least one vent hole, wherein the cap maintains the diaphragm in contact with the seat along an entire perimeter of the seat when the cap is in the first angular position and does not maintain the diaphragm in contact with the seat along its entire perimeter when the cap is in the second angular position, the opening being closed by the diaphragm when the cap is in the first angular position, and the diaphragm being free to deform so that a portion thereof is not in contact with the seat when the cap is in the second angular position.

Another aspect of the invention is a bag comprising: a receptacle having a mouth at an upper end and comprising a wall having an aperture; a plastic zipper joined to the mouth, wherein the zipper comprises first and second zipper strips that extend across the mouth, the first zipper strip comprising a first closure profile and the second zipper strip comprising a second closure profile, the first and second closure profiles being mutually interlockable to form a hermetic seal, the mouth being closed when the first and second closure profiles are interlocked and being open when the first and second closure profiles are disengaged; and a one-way valve assembly installed in the aperture in the wall of the receptacle and comprising: a valve base comprising an opening, a seat disposed along a periphery of the opening, a flange surrounding the seat and joined to the wall of the receptacle, and first and second pivot supports; a flapper comprising a diaphragm that is deformable and overlies the opening; and a cap pivotably supported by the first and second pivot supports for pivoting between first and second angular positions, the cap comprising at least one vent hole, wherein the cap maintains the diaphragm in contact with the seat along an entire perimeter of the seat when the cap is in the first angular position and does not maintain the diaphragm in contact with the seat along its entire perimeter when the cap is in the second angular position, the opening being closed by the diaphragm when the cap is in the first angular position, and the diaphragm being free to deform so that a portion thereof is not in contact with the seat when the cap is in the second angular position.

A further aspect of the invention is a bag comprising: a receptacle having a mouth at an upper end and comprising a wall having an aperture; a resealable hermetic sealing device joined to the mouth; and a one-way valve assembly installed in the aperture in the wall of the receptacle and comprising: a valve base comprising an opening, a seat disposed along a periphery of the opening, a flange surrounding the seat and joined to the wall of the receptacle, and first and second pivot supports; a flapper comprising a diaphragm that is deformable and overlies the opening; and a cap pivotably supported by the first and second pivot supports for pivoting between first and second angular positions, the cap comprising at least one vent hole, wherein the cap maintains the diaphragm in contact with the seat along an entire perimeter of the seat when the cap is in the first angular position and does not maintain the diaphragm in contact with the seat along its entire perimeter when the cap is in the second angular position, the opening being closed by the diaphragm when the cap is in the first angular position, and the diaphragm being free to deform so that a portion thereof is not in contact with the seat when the cap is in the second angular position.

Other aspects of the invention are disclosed and claimed below.

### BRIEF DESCRIPTION OF THE DRAWINGS

FIG. 1 is a drawing showing an isometric view of one conventional type of collapsible, evacuable storage bag.

FIG. 2 is a drawing showing an isometric view, from above, of a valve assembly with press-to-open cap suitable for use with a bag of the type depicted in FIG. 1.

FIG. 3 is a drawing showing an isometric view, from above, of the valve assembly depicted in FIG. 2, but with the press-to-open cap removed to reveal a flapper element.

FIG. 4 is a drawing showing an isometric view, from above, of the valve assembly depicted in FIG. 2, but with the press-to-open cap in the open position for extracting air from the storage bag (not shown) via a vacuum source (not shown).

FIG. 5 is a drawing showing a cross-sectional view of the valve assembly depicted in FIG. 4, i.e., with the cap in its open position. The section is taken along a plane normal to the cap's pivot axis.

FIG. 6 is a drawing showing an isometric view, from below, of a ribbed valve base of the valve assembly depicted in FIG. 2.

FIG. 7 is a drawing showing a cross-sectional view of the valve assembly depicted in FIG. 2, i.e., with the cap in its closed position. The section is taken along a plane normal to the cap's pivot axis.

FIGS. 8 and 9 are drawings showing cross-sectional views of alternative embodiments of the valve assembly depicted in FIG. 2. In each of FIGS. 8 and 9, the section is taken along a plane parallel to the cap's pivot axis and the cap is shown in its closed position.

FIG. 10 is a drawing showing an isometric view, from above, of a valve assembly with press-to-open cap of alternative design.

Reference will now be made to the drawings in which similar elements in different drawings bear the same reference numerals.

### DETAILED DESCRIPTION OF THE INVENTION

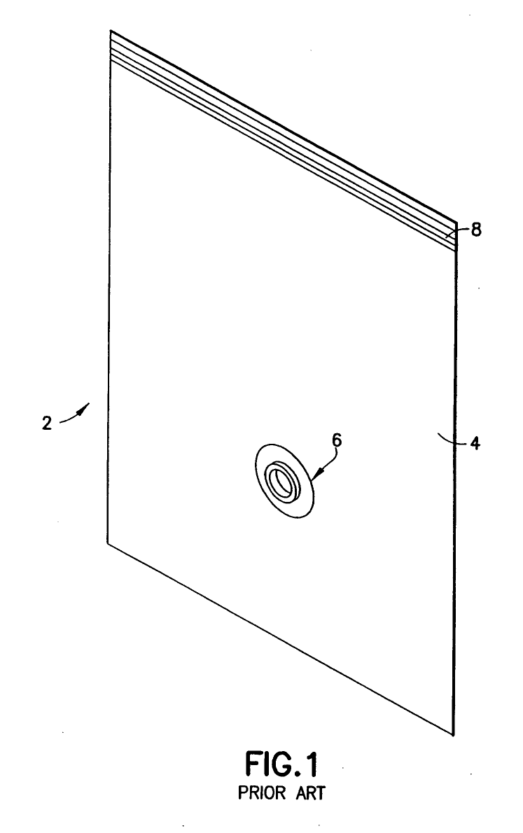

FIG. 1 shows a conventional collapsible, evacuable storage container 2 comprising a bag 4, a valve assembly 6, and a zipper 8 comprising a pair of mutually interlockable extruded zipper strips that are joined to each other at opposing ends thereof. Although not shown in FIG. 1, the conventional valve assembly 6 also typically comprises a cap that can be snapped onto a portion of the valve assembly that is disposed on the exterior of the bag 4. The cap must be removed before the bag can be evacuated, and then is replaced after the bag has been evacuated. The cap is intended to supplement the air pressure on the diaphragm and help to seal the valve assembly to prevent air from entering the evacuated bag.

The bag 4 typically comprises front and rear walls or panels (made of thermoplastic material) that are joined together at the bottom and two sides by conduction heat sealing to form a receptacle having an interior volume and a mouth in which the zipper 8 is installed. One wall of bag 4 has a hole (not shown in FIG. 1) in which to install the valve assembly 6. The bag may be constructed of a blended extrusion layer of polyethylene sandwiched between a nylon layer and a layer of polyethylene sheeting. However, the materials comprising the bag may be altered so as to prevent interaction with the bag contents.

During use, one or more discrete articles or a bulk material (not shown) may be placed inside the bag 4 while the zipper 8 is open, i.e., while the closure profiles of the interlockable zipper strips are disengaged from each other. After the article or material to be stored has been placed inside the bag, the mouth of the bag 4 can be sealed by pressing the zipper strips together to cause their respective closure profiles to interlock with each other. Although the zipper closure profiles may have many different designs, the design must be one that ensures that an airtight seal can be formed at the mouth of the bag.

With the zipper 8 closed, the interior volume of the bag or receptacle 4 is hermetically sealed. The interior volume can now be evacuated by sucking air out of the bag via the one-way valve assembly 6. Air can be drawn out of bag 4 through valve assembly 6 using a conventional vacuum source, such as a household or industrial vacuum cleaner. The valve assembly 6 and the zipper 8 maintain the vacuum inside bag 4 after the vacuum source is removed.

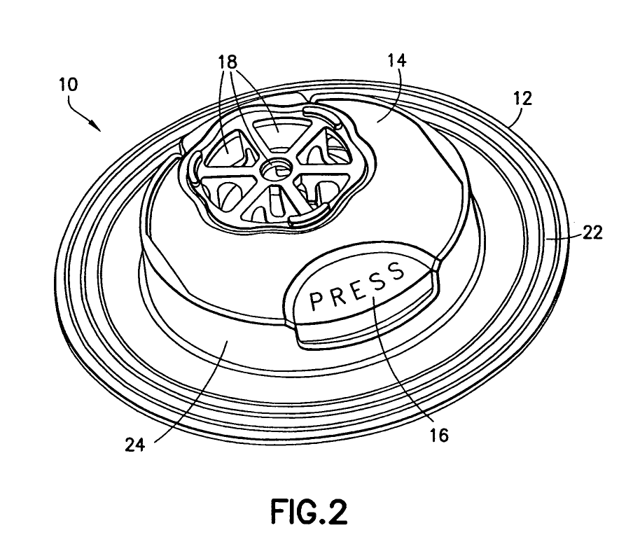

A valve assembly 10 in accordance with one embodiment of the present invention will now be described with reference to FIGS. 2-8. This valve assembly 10 can be substituted for the prior art valve assembly 6 in storage bags of the type depicted in FIG. 1.

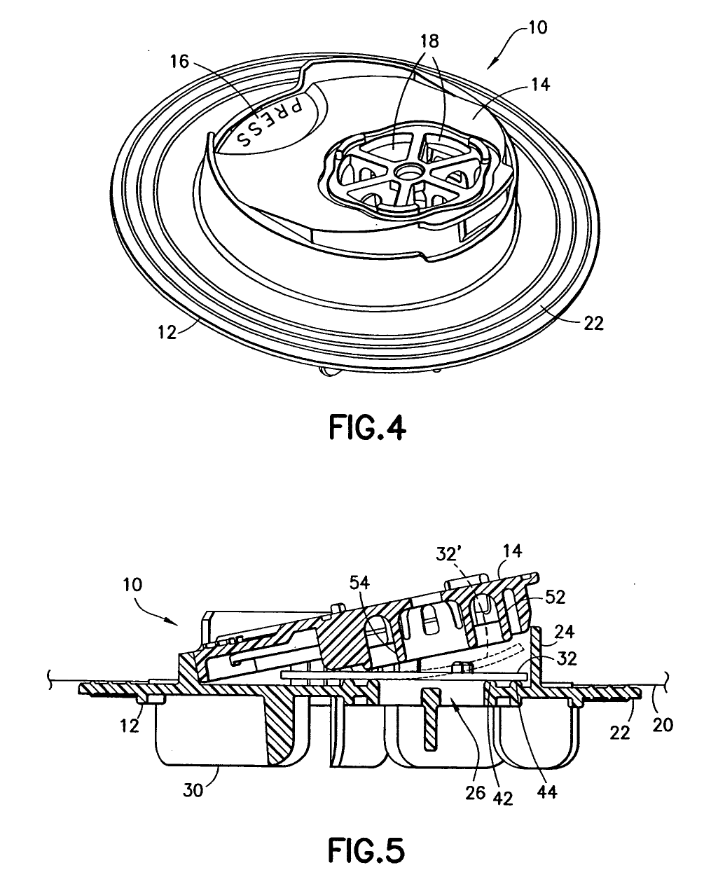

FIGS. 2 and 4 are isometric views, from above, showing a valve assembly 10, in closed and open states respectively, in accordance with one embodiment. The valve assembly 10 comprises a valve base 12 and a press-to-open, press-to-close cap 14 pivotably mounted to the valve base 12. The cap 14 is provided with a plurality of vent holes 18 which allow air to flow through the cap 14 during bag evacuation. In particular, when the valve is open, i.e., when cap 14 is in its open position as seen in FIG. 4, air can be sucked out of a storage bag via vent holes 18 using devices such as common household vacuum cleaner. Both the valve base 12 and the cap 14 are preferably made of injection-molded thermoplastic material.

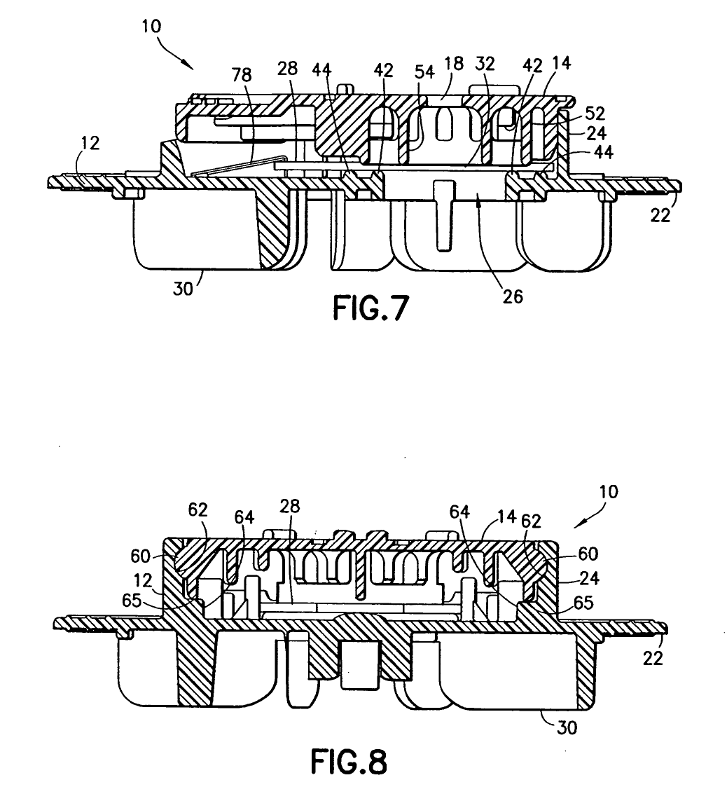

The cap 14 is shown in its closed position in FIG. 2 and in its open position in FIG. 4. Portion 16 of cap 14 bears the legend “PRESS” and indicates the area where a user should apply pressure with a digit or utensil in order to open the valve by causing the cap 14 to pivot about an axis from its closed position (seen in FIGS. 2 and 7) to its open position (seen in FIGS. 4 and 5).

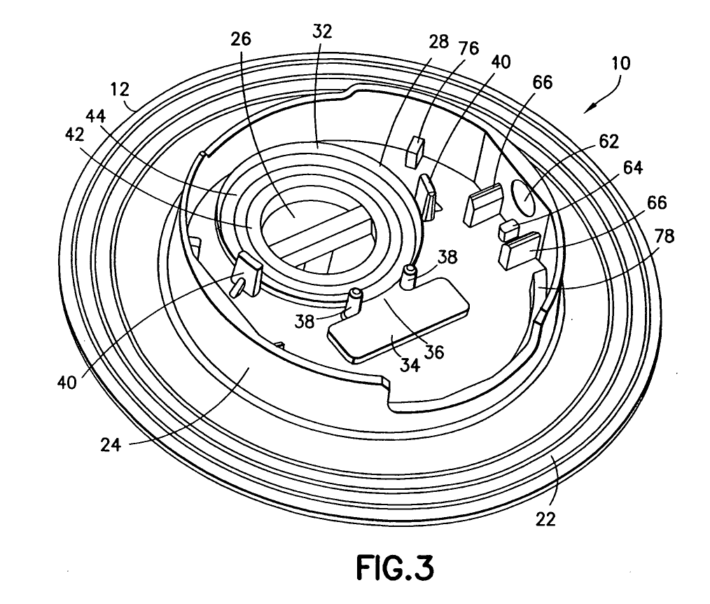

FIG. 3 shows the valve assembly 10 with the cap removed to reveal a flapper or valve element 28, which is also a component of the valve assembly 10. The flapper 28 comprises a diaphragm 32 connected to a base portion 34 by means of a necked portion 36. In a known embodiment, the flapper 28 is made of clear polyvinylchloride (PVC).

As also shown in FIG. 3, the valve base 12 has an opening 26 that is covered by the diaphragm 32 of the flapper 28. In the valve closed state, the diaphragm 32 sits on a pair of concentric annular beads 42 and 44 that project upward from the valve base 12 and encircle opening 26. The position of the flapper 28 is dictated by a pair of flapper positioning posts 38 and a pair of retainer tabs 40, which are integrally formed as parts of the molded valve base 12. The flapper positioning posts 38 are positioned such that they can loosely control the position of the flapper 28. In particular, the gap between posts 38 is slightly larger than the width of the necked portion 36 of the flapper 28. The allowance gap is defined by the process tolerance of injection molding. The retainer tabs 40 retain the diaphragm 32 in a position overlying the opening 26 in the valve base 12.

The flapper 28 provides the one-way airflow feature in valve assembly 10. The valve can be opened by pressing portion 16 of the cap 14 (see FIG. 4). Upon being pressed, the cap 14 will pivot around a pivot point and be in an open state when it reaches the angular position depicted in FIG. 5. When the cap 14 is pivoted to this valve open position, the flapper will be free to lift open in the allowed space underneath the cap. This cap position allows air to be extracted from the bag. A vacuum source (not shown) can be placed with the terminus of its nozzle pressed against the base flange 22 to draw air through the valve. The suction applied by the vacuum nozzle causes the diaphragm 32 to flex open. Then air inside the bag passes through opening 26 in base 12, through vent holes 18 in cap 14, and into the vacuum nozzle. The opening 26 in the base 12 is in fluid communication with the multiplicity of vent holes 18 in cap 14 when any portion of the diaphragm 32 is lifted off of the annular beads 42 and 44. One such position of the diaphragm 32 is indicated in FIG. 5 by dashed lines 32′.

When the vacuum source nozzle is removed, diaphragm 32 returns to its original shape and bears against beads 42 and 44. Once the pressure inside the bag is less than that of the outside atmospheric pressure, the “vacuum” inside the bag is maintained due to the atmospheric pressure applied onto the flapper's upper surface. The valve can then be securely closed by pressing down the portion of cap 14 that is diametrally opposite to portion 16. The valve closed position of cap 14 is best seen in FIG. 7.

Referring to FIG. 7, in the valve closed position the diaphragm of flapper 28 is held down by the rims of a pair of concentric downwardly depending walls 52 and 54 integrally formed on the cap 14. More specifically, walls 52, 54 have heights designed so that their rims press the diaphragm 32 of flapper 28 against the beads 42, 44 of valve base 12, thus creating an airtight seal that prevents air from flowing in a reverse direction through the opening 26 in base 12. Preferably the wall 52 has a diameter slightly greater than the diameter of bead 42, but less than the diameter of bead 44, while wall 54 has a diameter less than the diameter of bead 42. In this valve closed state. there is no fluid communication between opening 26 in base 12 and vent holes 18 in cap 14 (only one of the vent holes 18 is visible in FIG. 7), that is, opening 26 is not a flow path for leakage of ambient air into the evacuated storage bag.

As seen in FIG. 5, the valve assembly 10 is mounted to a wall 20 of a storage bag such that a flange 22 of base 12 is on the inside of the bag. Base 12 has an upright wall 24 that extends generally perpendicular to the plane of flange 22 and through a hole in the bag wall. The base 12 is held in place by welding the base flange 22 to the material of bag wall 20 to provide a seal. In a preferred embodiment, the valve base 12 is permanently attached to the bag wall 20 by heat sealing. The heat seal makes a complete circle around the circumference of the hole in the bag wall through which wall 24 of base 12 projects, thereby blocking the passage of air between the bag wall 20 and the base flange 22 and then out the hole in the bag wall. Optionally a retaining ring may be placed over the base 12 on the outside of the bag to cover the weld area on base flange 22.

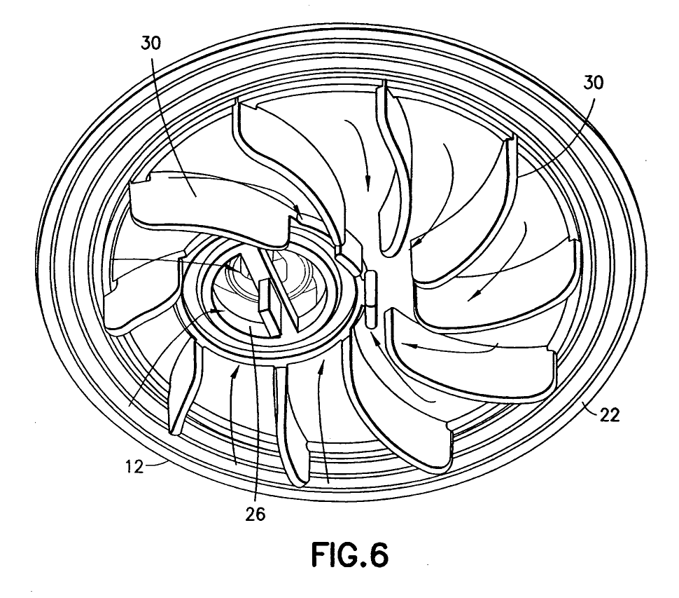

As best seen in FIG. 6, a plurality of curved vanes 26 project downward from the bottom of the valve base to allow sufficient airflow paths (indicated by curved arrows in FIG. 6) between the upper and lower bag film layers (not shown) and toward opening 26 in base 12 during evacuation.

Optionally, means are provided on the flange 22 of base 12 for improving the speed of the conduction heat sealing operation by which the valve assembly is attached to the bag. As shown in FIG. 5, the foregoing means comprise a series of concentric circular beads formed on the upper surface of the flange 22 to which the bag wall 20 is joined. In the example shown in FIG. 5, three circular beads are provided, with the difference in radius of the outer and middle beads being equal to the difference in radius of the inner and middle beads. Each of the beads has a respective profile that is generally constant along its circumference, which profiles may be substantially the same for the three beads. During the sealing operation (sealing the base of the valve assembly to the bag making film), a portion of the bag making film on the periphery of the hole through which the valve base 12 passes is pressed between a heated annular sealing ring (not shown) and the flange 22 of base 12. Portions of one or more of the beads are melted along the entire circumference of the sealing ring during the heat sealing operation, thereby providing an annular hermetic seal around the hole in the bag. The beads act as heat concentrators during the sealing operation. The beads melt rapidly and then fuse to the bag making film to form the hermetic seal during cooling. The presence of these heat-concentrating beads speeds up the conduction heat sealing process, thereby reducing the cost of manufacture.

As best seen in FIG. 8, the pivotable cap 14 may comprise a pair of pivot hinges 60 formed by rounded projections in the shape of a section of a sphere. These pivot hinges are disposed on opposite sides of the cap and are seated in respective spherical pivot hinge indentations 62 formed on the inside of wall 24 of the valve base 12. Below each pivot hinge 60, the cap has respective round pivoting edges 65. The round pivoting edges of the cap are supported by pivot support posts 64 and 66 (best seen in FIG. 3), which are integrally molded as parts of the valve base 12.

Still referring to FIG. 3, the valve base 12 further comprises a pair of cap support posts 76 (only one of which is visible in FIG. 3) that stop the cap 14 when it reaches the correct valve closed position during the valve closing operation (press to close). In addition, the valve base 12 comprises a pair of cap support ledges 78 (only one of which is visible in FIG. 3) that provide additional support for the cap during the valve opening operation (press to open). Each ledge 78 has an inclined contact surface, as best seen in FIG. 7.

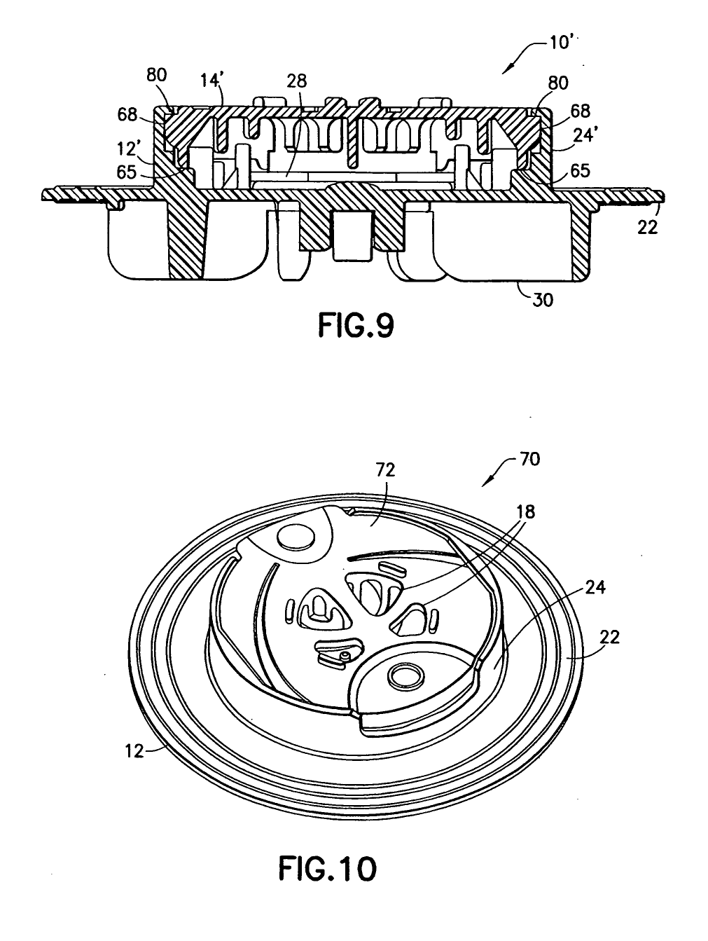

FIG. 9 shows a cross-sectional view of an alternative embodiment of a valve assembly 10′. In this embodiment, the cap pivot hinges 68 of cap 14′ each have a round pivoting upper edge. Each cap pivot hinge 68 is received in a respective indentation on the inside of wall 24′ of the valve base 12′ when the cap 14′ is snapped into place. Pivot support posts similar to posts 64 and 66 seen in FIG. 3 are also provided, which pivot support posts supports the round pivoting edges of cap 14′.

FIG. 10 shows an isometric view, from above, of a valve assembly 70 with press-to-open cap 72 of alternative design. This valve assembly differs from the assembly seen in FIG. 2 in the location and configuration of the vent holes 18, but otherwise may have the same structure as described in detail above.

The evacuable storage bag 2 (see FIG. 1) may be constructed from two panels of film joined together (e.g., by conduction heat sealing) along three sides of a rectangle. To maintain a vacuum inside the storage bag, the zipper 8 in a closed state must provide a hermetic seal at the mouth (i.e., fourth side) of the bag. Many different types of zippers can be used. The present invention is not directed to any particular zipper construction. For the sake of illustration, however, a suitable zipper for use with the present invention is described in U.S. Published Patent Application Publ. No. 2005/0211319 (see FIG. 13 therein and associated description), the contents of which is fully incorporated by reference herein.

The person skilled in the art of manufacturing reclosable bags on a machine would readily appreciate that instead of forming the bag from two separate webs of plastic film joined together on three sides, the bag can be formed from a single web of film that has been folded. In the completed bag, this fold will form the bottom of the bag, while the two side seals are formed by conduction heat sealing.

While the invention has been described with reference to preferred embodiments, it will be understood by those skilled in the art that various changes may be made and equivalents may be substituted for members thereof without departing from the scope of the invention. In addition, many modifications may be made to adapt a particular situation to the teachings of the invention without departing from the essential scope thereof. Therefore it is intended that the invention not be limited to the particular embodiment disclosed as the best mode contemplated for carrying out this invention, but that the invention will include all embodiments falling within the scope of the appended claims.

As used in the claims, the verb “joined” means fused, bonded, sealed, tacked, adhered, etc., whether by application of heat and/or pressure, application of ultrasonic energy, application of a layer of adhesive material or bonding agent, interposition of an adhesive or bonding strip, etc.

1. A valve assembly comprising:
a valve base comprising an opening, a seat disposed along a periphery of said opening, a flange surrounding said seat, and first and second pivot supports;
a flapper comprising a diaphragm that is deformable and overlies said opening; and
a cap pivotably supported by said first and second pivot supports for pivoting between first and second angular positions, said cap comprising at least one vent hole,
wherein said cap maintains said diaphragm in contact with said seat along an entire perimeter of said seat when said cap is in said first angular position and does not maintain said diaphragm in contact with said seat along its entire perimeter when said cap is in said second angular position, said opening being closed by said diaphragm when said cap is in said first angular position, and said diaphragm being free to deform so that a portion thereof is not in contact with said seat when said cap is in said second angular position.

2. The valve assembly as recited in claim 1, wherein said seat comprises a first bead that surrounds said opening.

3. The valve assembly as recited in claim 2, wherein said valve seat further comprises a second bead that surrounds said first bead, said diaphragm being in contact with said second bead along an entire perimeter of said second bead when said cap is in said first angular position.

4. The valve assembly as recited in claim 1, wherein said cap comprises a wall having a rim that contacts said diaphragm along an entire perimeter of said rim when said cap is in said first angular position, said rim and said seat being on opposite sides of said diaphragm.

5. The valve assembly as recited in claim 2, wherein said cap comprises a first wall having a rim that contacts said diaphragm along an entire perimeter of said rim when said cap is in said first angular position, said rim of said first wall having a diameter greater than a diameter of said first bead.

6. The valve assembly as recited in claim 3, wherein said cap comprises a first wall having a rim that contacts said diaphragm along an entire perimeter of said rim when said cap is in said first angular position, said rim of said first wall having a diameter greater than a diameter of said first bead and less than a diameter of said second bead.

7. The valve assembly as recited in claim 5, wherein said cap further comprises a second wall having a rim that contacts said diaphragm when said cap is in said first angular position, said rim of said second wall having a diameter less than said diameter of said first bead.

8. The valve assembly as recited in claim 1, wherein said flapper further comprises a base portion and a necked portion connecting said diaphragm to said base portion, and wherein said valve base further comprises first and second flapper positioning posts, said necked portion of said flapper being disposed between said first and second flapper positioning posts.

9. The valve assembly as recited in claim 1, wherein said valve base further comprises first and second retainer tabs that flank said diaphragm.

10. The valve assembly as recited in claim 1, wherein said valve base comprises a wall that surrounds said cap when said cap is in said first angular position, said first and second pivot supports comprising respective depressions formed in said wall of said valve base.

11. A bag comprising:
a receptacle having a mouth at an upper end and comprising a wall having an aperture;
a plastic zipper joined to said mouth, wherein said zipper comprises first and second zipper strips that extend across said mouth, said first zipper strip comprising a first closure profile and said second zipper strip comprising a second closure profile, said first and second closure profiles being mutually interlockable to form a hermetic seal, said mouth being closed when said first and second closure profiles are interlocked and being open when said first and second closure profiles are disengaged; and
a one-way valve assembly installed in said aperture in said wall of said receptacle and comprising:
a valve base comprising an opening, a seat disposed along a periphery of said opening, a flange surrounding said seat and joined to said wall of said receptacle, and first and second pivot supports;
a flapper comprising a diaphragm that is deformable and overlies said opening; and
a cap pivotably supported by said first and second pivot supports for pivoting between first and second angular positions, said cap comprising at least one vent hole,
wherein said cap maintains said diaphragm in contact with said seat along an entire perimeter of said seat when said cap is in said first angular position and does not maintain said diaphragm in contact with said seat along its entire perimeter when said cap is in said second angular position, said opening being closed by said diaphragm when said cap is in said first angular position, and said diaphragm being free to deform so that a portion thereof is not in contact with said seat when said cap is in said second angular position.

12. The valve assembly as recited in claim 11, wherein said seat comprises a first bead that surrounds said opening.

13. The valve assembly as recited in claim 12, wherein said valve seat further comprises a second bead that surrounds said first bead, said diaphragm being in contact with said second bead along an entire perimeter of said second bead when said cap is in said first angular position.

14. The valve assembly as recited in claim 11, wherein said cap comprises a wall having a rim that contacts said diaphragm along an entire perimeter of said rim when said cap is in said first angular position, said rim and said seat being on opposite sides of said diaphragm.

15. The valve assembly as recited in claim 12, wherein said cap comprises a first wall having a rim that contacts said diaphragm along an entire perimeter of said rim when said cap is in said first angular position, said rim of said first wall having a diameter greater than a diameter of said first bead.

16. The valve assembly as recited in claim 15, wherein said cap further comprises a second wall having a rim that contacts said diaphragm when said cap is in said first angular position, said rim of said second wall having a diameter less than said diameter of said first bead.

17. The bag as recited in claim 11, wherein said flapper further comprises a base portion and a necked portion connecting said diaphragm to said base portion, and wherein said valve base further comprises first and second flapper positioning posts, said necked portion of said flapper being disposed between said first and second flapper positioning posts.

18. The bag as recited in claim 11, wherein said valve base further comprises first and second retainer tabs that flank said diaphragm.

19. The bag as recited in claim 11, wherein said valve base comprises a wall that surrounds said cap when said cap is in said first angular position, said first and second pivot supports comprising respective depressions formed in said wall of said valve base.

20. A bag comprising:
a receptacle having a mouth at an upper end and comprising a wall having an aperture;
a resealable hermetic sealing device joined to said mouth; and
a one-way valve assembly installed in said aperture in said wall of said receptacle and comprising:
a valve base comprising an opening, a seat disposed along a periphery of said opening, a flange surrounding said seat and joined to said wall of said receptacle, and first and second pivot supports;
a flapper comprising a diaphragm that is deformable and overlies said opening; and
a cap pivotably supported by said first and second pivot supports for pivoting between first and second angular positions, said cap comprising at least one vent hole,
wherein said cap maintains said diaphragm in contact with said seat along an entire perimeter of said seat when said cap is in said first angular position and does not maintain said diaphragm in contact with said seat along its entire perimeter when said cap is in said second angular position, said opening being closed by said diaphragm when said cap is in said first angular position, and said diaphragm being free to deform so that a portion thereof is not in contact with said seat when said cap is in said second angular position.
